(19) United States
(12) Patent Application Publication
(10) Pub. No.: US 2012/0246384 A1
(43) Pub. Date: Sep. 27, 2012

(54) FLASH MEMORY AND FLASH MEMORY ACCESSING METHOD

(75) Inventors: Chi-Cheng Lin, Miaoli County (TW); Jun-Lin Yeh, Hsinchu County (TW)

(73) Assignee: WINBOND ELECTRONICS CORP., Taichung City (TW)

(21) Appl. No.: 13/053,194

(22) Filed: Mar. 21, 2011

(51) Int. Cl. G06F 12/02

(52) U.S. Cl. 711/103; 711/E12.008

(57) ABSTRACT

A flash memory accessing method is provided. The method includes: firstly, dividing the flash memory into a primary storage area and a backup storage area, wherein the difference between a first start address of the primary storage area and a second start address of the backup storage area is an offset address not equal to zero; reading the flash memory according to a address pointer equal to the first start address so as to obtain the boot data; making the electronic apparatus perform a boot sequence according to the boot data; then, detecting whether the boot sequence is normal or not, and when the boot sequence is abnormal, providing the flash memory with changing the read pointer to the second start address according to an offset address to read the backup boot data.

### BACKGROUND OF THE INVENTION

1. Field of the Invention

The invention generally relates to a flash memory accessing method, and more particularly, to an accessing method of backup data in a flash memory.

2. Description of Related Art

In recent years, with the overwhelming advantage of large memory size and high rewriting speed, the flash memory has played a major role in the non-volatile memory market.

However, a flash memory after performing data operations many times would have a risk of damage. Once the flash memory is accidently corrupted because of inappropriate electronic apparatus design, the renewing operations of the flash memory is unable to be applied into every memory block in average, and the frequently-used memory blocks may thereby get damage. Usually, relatively important data, for example, boot data of the electronic apparatus to which the flash memory belongs are stored in the often damaged memory blocks.

When the boot data of the electronic apparatus is unable to be read out due to damage of the flash memory, the entire electronic apparatus would fail to be booted and completely shut down. To resume such electronic apparatus to work, professional maintenance and instrument are always needed, which causes a lot of inconvenience in the use.

### SUMMARY OF THE INVENTION

Accordingly, the invention is directed to a flash memory accessing method to ensure an electronic apparatus to be normally booted up.

The invention is also directed to a flash memory disposed on an electronic apparatus to ensure the electronic apparatus to be normally booted up.

The invention provides a flash memory accessing method. The method includes: firstly, dividing the flash memory into a primary storage area and a backup storage area, wherein the difference between a first start address of the primary storage area and a second start address of the backup storage area is an offset address not equal to zero; reading the flash memory according to a address pointer equal to the first start address so as to obtain the boot data; making the electronic apparatus perform a boot sequence according to the boot data; then, detecting whether the boot sequence is normal or not; and when the boot sequence is abnormal, providing the flash memory with changing the read pointer to the second start address according to the offset address to read the backup boot data.

The invention provides a flash memory, disposed on the electronic apparatus. The flash memory includes a flash memory and an address allocator. The flash memory is divided into a primary storage area and a backup storage area, and the address allocator is coupled to the flash memory. The primary storage area is for storing a boot data and the backup storage area is for storing the boot data serving as a backup boot data. The address allocator is built in the flash memory for receiving a first start address and a boot normal signal and producing a read pointer according to a boot normal signal, a first start address and an offset address to provide the read pointer for reading the boot data or the backup boot data by providing the read pointer.

Based on the depiction above, in the invention, the flash memory disposed in the electronic apparatus is divided into the primary storage area and the backup storage area, and a boot data is stored in both the primary storage area and the backup storage area. Moreover, it is detected whether the boot is successful or not so as to decide whether or not to read the boot data in the backup storage area for boot. In this way, the electronic apparatus is ensured to be normally booted up to avoid the electronic apparatus from completely failing to be activated due to damage of the flash memory.

In order to make the aforementioned and other features and advantages of the invention comprehensible, several exemplary embodiments accompanied with figures are described in detail below.

### BRIEF DESCRIPTION OF THE DRAWINGS

FIG. 1 is a flow chart diagram of a flash memory accessing method according to an embodiment of the invention.

FIGS. 2A and 2B are respectively an operation diagram of the embodiment of the invention.

FIG. 3 is a diagram of a flash memory 300 according to an embodiment of the invention.

### DESCRIPTION OF THE EMBODIMENTS

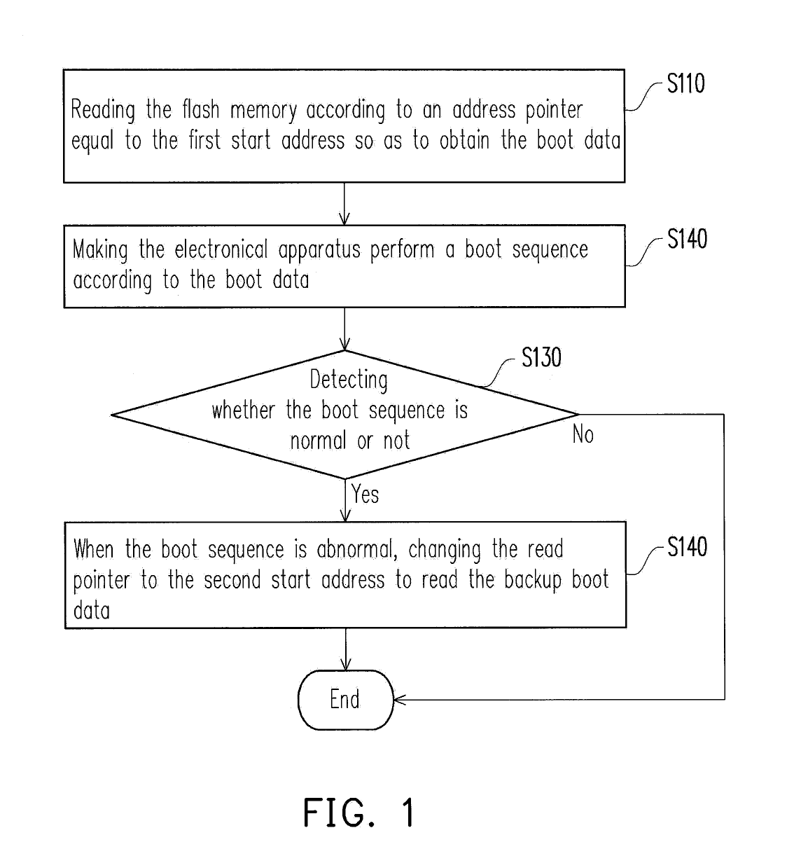

Referring to FIG. 1, FIG. 1 is a flow chart diagram of a flash memory accessing method according to an embodiment of the invention. The flash memory of the embodiment is divided into two areas: one is a primary storage area and another is a backup storage area. The way of dividing the flash memory into the two areas is: setting two different start addresses for the flash memory so as to distinguish the memory blocks respectively belonging to the primary storage area and the backup storage area. For example, it is assumed the physical address of 000000H of the flash memory is set as the start address of the primary storage area and the physical address of 400000H of the flash memory is set as the start address of the backup storage area. Then, the memory blocks with the memory physical addresses of 000000H-3FFFFFH belong to the primary storage area and the memory blocks after the physical address of 400000H of the flash memory belong to the backup storage area.

It should be noted that the memory capacity of the backup storage area should not be planed to be greater than the storage capacity of the primary storage area.

The boot data can be cloned to two copies and the two copies are simultaneously stored in the primary storage area and the backup storage area, wherein the boot data stored in the backup storage area is also referred to a backup boot data.

The flash memory accessing method in the embodiment includes following steps. The start address of the primary storage area is set as a read pointer and the read pointer is used to read the primary storage area so as to obtain the boot data stored in the primary storage area (S110). During reading the data in the primary storage area, the reading is performed according to the read pointer and the memory address which is directed by the read pointer and is ascending along with the ongoing reading operations. When the memory addresses directed by the read pointer are the memory addresses for storing the boot data, the boot data is read and obtained.

After obtaining the boot data, the electronic apparatus to which the flash memory belongs can perform a boot sequence according to the boot data (S120). The status of the boot sequence performed by the electronic apparatus is detected (S130). The detection method on the status of the boot sequence performed by the electronic apparatus is to execute one or a plurality of boot testing programs after the electronic apparatus performs the boot sequence so as to observe whether or not the electronic apparatus has a response to the boot testing programs and the reply is normal. Once the electronic apparatus has the normal reply to the boot testing programs, it indicates the electronic apparatus has been normally booted up, which means the boot data read from the primary storage area is normal. If the electronic apparatus does not response to the boot testing programs normally, it indicates the boot data read from the primary storage area is abnormal and a portion of the boot data stored in the primary storage area may be damaged.

To confirm whether or not the electronic apparatus has the normal reply to the boot testing programs, a time-counting operation performed simultaneously with executing the boot testing programs is used. For example, firstly, the previous time-counting operation is resetted and a new time-counting operation is started simultaneously with executing the boot testing programs. When the time-counting operation gets overflow and the electronic apparatus has not had a normal reply according to the executed boot testing programs, it indicates the boot sequence of the electronic apparatus is not accomplished. On the contrary, when the electronic apparatus successfully has a normal reply according to the executed boot testing programs before the time-counting operation gets overflow, the time-counting operation is resetted and it is confirmed that the boot sequence of the electronic apparatus is effectively accomplished.

When the detection result of the status of the boot sequence indicates the electronic apparatus is not normally booted up, the read pointer is changed to the start address of the backup storage area, and then the boot data stored in the backup storage area is read according to the new read pointer (S140). In this way, when the boot data in the primary storage area is damaged, the electronic apparatus still can perform the boot sequence according to the boot data in the backup storage area so as to keep the normal work ability thereof.

The read pointer can be changed in this way that the difference between the start address of the primary storage area and the start address of the backup storage area is recorded, wherein the difference serves as an offset address, and when the read pointer needs to be changed, the updated read pointer is directly equal to the sum of the start address of the primary storage area and the offset address.

When it is found that the boot data in the primary storage area is unable to make the electronic apparatus normally booted up, the boot data read from the backup storage area is written back into the primary storage area to overwrite the present boot data thereof. After the writing operation, if the primary storage area has no physical damage, the boot data in the primary storage area can be recovered for normal work.

That is to say, in the embodiment of the invention, when the boot data stored in the primary storage area fails to provide a normal boot data for the electronic apparatus to which the flash memory belongs, the flash memory in the embodiment of the invention can, merely by receiving the information for the electronic apparatus, switch the read pointer according to the offset address to read the backup boot data in the backup storage area. In this way, the electronic apparatus can be effectively booted up so as to keep the operation of the system.

In particular, both the primary storage area and the backup storage area are not for storing the boot data only. A plurality of data required by the electronic apparatus can be stored in the primary storage area, and the important data (for example, the boot data) in the primary storage area are stored in the backup storage area so as to ensure the safety of the important data in the primary storage area.

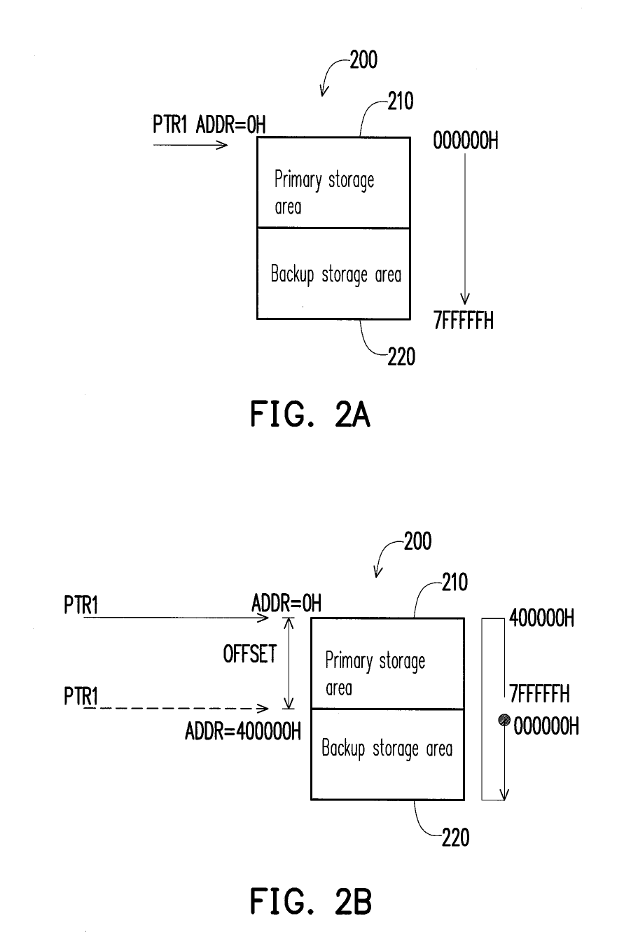

To be specific for the implementation, referring to FIGS. 2A and 2B, FIGS. 2A and 2B are respectively an operation diagram of the embodiment of the invention. In FIG. 2A, the read pointer PTR1 is set to be equal to the start address of the primary storage area 210 (the physical address ADDR=0H), and the reading operation on the flash memory 200 is performed according to the read pointer PTR1. In other words, the physical address ADDR=0H of the flash memory 200 is corresponding to the logical address 000000H of the flash memory 200. When the boot data in the primary storage area 210 fails to make the electronic apparatus normally boot up, the read pointer PTR1 is reset to the start address of the backup storage area 220 (the physical address ADDR=400000H). The above-mentioned renewing operation of the read pointer PTR1 can be done by adding the offset address OFFSET to the start address of the primary storage area 210 so as to obtain the new read pointer PTR1, wherein the offset address OFFSET is not equal to zero.

After the read pointer PTR1 is changed, the physical address ADDR=400000H of the flash memory 200 is corresponding to the logical address 000000H of the flash memory 200, while the physical address ADDR=0H of the flash memory 200 is corresponding to the logical address 400000H of the flash memory 200.

When the reading operation on the flash memory 200 is performed according to the new read pointer PTR1 equal to the start address of the backup storage area 220, once the reading operation goes on to the last address of the backup storage area 220, the read pointer is renewed again to be equal to the start address of the primary storage area 210, followed by reading the flash memory 200.

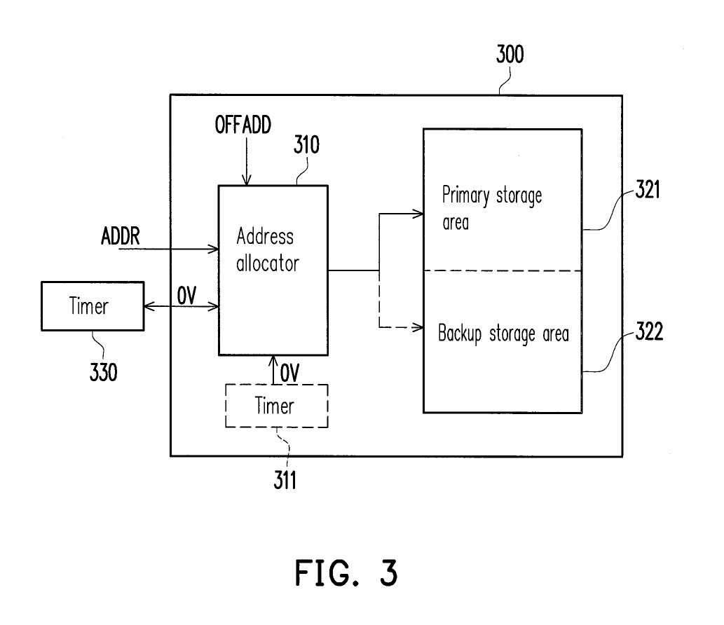

FIG. 3 is a diagram of a flash memory 300 according to an embodiment of the invention. Referring to FIG. 3, the flash memory 300 is disposed on an electronic apparatus. The flash memory 300 includes an address allocator 310, a primary storage area 321, a backup storage area 322 and a timer 311. The address allocator 310 can be an address decoder coupled to the primary storage area 321 and the backup storage area 322. The primary storage area 321 and the backup storage area 322 are respectively for storing a boot data and a backup boot data. The address allocator 310 reads the flash memory 300 according to a read pointer equal to the start address ADDR so as to obtain the boot data and make the electronic apparatus perform a boot sequence according to the boot data.

After the electronic apparatus in the embodiment performs the boot sequence, the electronic apparatus itself would detect whether the boot is normal or not, and the detection result is obtained by another timer 330. Briefly, during the electronic apparatus is detecting whether the boot is normal or not, the timer 330 would start the time-counting operation thereof. If the boot sequence of the electronic apparatus is normal, the time-counting operation is reset in real time by the electric apparatus without producing overflow. On the contrary, if the boot sequence of the electronic apparatus is abnormal, the time-counting operation of the timer 330 is not reset and overflow is produced. An overflow signal OV indicating the overflow status serves as the boot normal signal and is transmitted to the address allocator 310. Then, the address allocator 310 would convert the read pointer by using an offset address OFFADD to the backup storage area 322 according to the overflow signal OV so as to read the backup boot data.

It should be noted that the timer 330 can be also a timer 311 built in the flash memory 300, and the above-mentioned timer 311 can be implemented by a circuit hardware or a software.

In summary, in the invention, it is detected whether the boot sequence is normal or not so as to decide the damage/safety status of the boot data in the primary storage area. When the boot data in the primary storage area is damaged, the address allocator in the flash memory is used to change the read pointer according to the boot normal signal and the offset address, so that the read pointer directs the start address of the backup storage area to read the backup boot data in the backup storage area, which enables the electronic apparatus normally boot up.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A flash memory accessing method, wherein the flash memory is disposed on an electronic apparatus, the flash memory comprises a primary storage area and a backup storage area for respectively storing a boot data and a backup boot data and the difference between a first start address of the primary storage area and a second start address of the backup storage area is an offset address not equal to zero; the flash memory accessing method comprising:
reading the flash memory according to a address pointer equal to the first start address so as to obtain the boot data;
making the electronic apparatus perform a boot sequence according to the boot data; and
detecting whether the boot sequence is normal or not; and
when the boot sequence is abnormal, providing the flash memory to change the read pointer to the second start address according to an offset address for reading the backup boot data.

2. The flash memory accessing method as claimed in claim 1, wherein the step of ‘detecting whether the boot sequence is normal or not’ further comprises:
resetting a time-counting operation;
performing at least a boot testing operation and starting the time-counting operation; and
when the time-counting operation gets overflow, judging whether the boot sequence is normal or not according to the boot testing operation.

3. The flash memory accessing method as claimed in claim 1, wherein the step of ‘changing the read pointer to the second start address according to an offset address to read the backup boot data’ comprises:
making the read pointer equal to the sum of the offset address and the first start address.

4. The flash memory accessing method as claimed in claim 1, wherein the storage capacity of the backup storage area is not greater than the storage capacity of the primary storage area.

5. The flash memory accessing method as claimed in claim 1, further comprising:
when performing a reading operation on the flash memory according to the read pointer equal to the second start address and the reading operation is continued to the last address of the backup storage area, making the read pointer equal to the first start address and continuously performing the reading operation on the flash memory.

6. The flash memory accessing method as claimed in claim 1, further comprising:
writing the backup boot data obtained through the reading operation according to the read pointer equal to the second start address back to the primary storage area so as to overwrite the boot data.

7. A flash memory disposed on an electronic apparatus comprising:
a primary storage area for storing a boot data;
a backup boot data for storing the boot data serving as a backup boot data; and
an address allocator built in the flash memory, receiving a first start address and a boot normal signal, producing a read pointer according to the boot normal signal, the first start address and an offset address and providing the read pointer to read the boot data or the backup boot data.

8. The flash memory as claimed in claim 7, further comprising:
a timer, coupled to the address allocator, performing a time-counting operation during the electronic apparatus is detecting whether the boot sequence is normal or not and transmitting an overflow signal serving as the boot normal signal to the address allocator according to whether the time-counting operation gets overflow or not.

9. The flash memory as claimed in claim 8, wherein when the time-counting operation gets overflow, the address allocator makes the read pointer equal to the sum of the first start address and the offset address and provides the read pointer equal to a second start address to read the backup boot data.

10. The flash memory as claimed in claim 8, wherein when no overflow happens with the time-counting operation, the address allocator makes the read pointer equal to the first start address and provides the read pointer to read the boot data.

11. The flash memory as claimed in claim 7, wherein the storage capacity of the backup storage area is not greater than the storage capacity of the primary storage area.

12. The flash memory as claimed in claim 7, wherein the address allocator further provides the read pointer equal to the second start address to read the backup boot data and provides the first start address serving as a writing pointer to write the backup boot data back to the primary storage area to overwrite the boot data.
